(19) United States
(12) Patent Application Publication
(10) Pub. No.: US 2002/0078117 A1
(43) Pub. Date: Jun. 20, 2002

(54) System for creating efficient multi-step document conversion services

(76) Inventors: Michelle Q. Wang Baldonado, Palo Alto, CA (US); Richard R. Burton, Palo Alto, CA (US); Steve B. Cousins, Cupertino, CA (US); Kenneth A. Pier, Mountainview, CA (US); James D. Thornton, Redwood City, CA (US)

Correspondence Address: FLIESLER DUBB MEYER & LOVEJOY, LLP, FOUR EMBARCADERO CENTER, SUITE 400, SAN FRANCISCO, CA, 94111, US

(21) Appl. No.: 09/740,487

(22) Filed: Dec. 19, 2000

(51) Int. Cl. G06F 9/00

(52) U.S. Cl. 709/101

(57) ABSTRACT

A job management apparatus for use in a batch job execution system is provided. The job management apparatus includes a client communications part which receives a batch job from a client, an extracting part which extracts a task from the batch job, and an assigning part which receives signals from the service providers and delegates a task to a service provider who is capable of performing such task. The job management apparatus is in communication with a job database which stores the batch job after it is received from the client. At least one provider manager is in communication with the job management apparatus and in communication with the service providers which monitors the tasks as they are being performed on a service provider and provides status information about the task to the job management apparatus. The service providers are configured to output signals to the job management apparatus requesting work.

### CROSS-REFERENCE TO RELATED APPLICATIONS

The following U.S. patent application is assigned to the assignee of the present application, is related to the present application and its disclosure is incorporated herein by reference: (A) U.S. patent application Ser. No. [______], [Attorney Docket No. XERX-1042US0] filed on Dec. 19,2000, by James D. Thornton, and Richard R. Burton, entitled a “METHOD AND SYSTEM FOR EXECUTING BATCH JOBS BY DELEGATING WORK TO INDEPENDENT SERVICE PROVIDERS.”

### FIELD

The present invention relates generally to the preparation and execution of batch jobs. More particularly, the present invention relates to managing the execution of batch jobs by preparing and organizing tasks within a job.

### BACKGROUND

Users of modern day computer systems and networks are imposing increasing demands on such systems to perform wider varieties and larger quantities of work. Because of these demands, it is becoming important to structure the work of a job in some organized form for processing. A “batch job” is one organized form in which work may be structured. A batch job may be any combination or grouping of files, documents or other instructions that work is to be performed on. It will be understood by one skilled in the art that a batch job may require one or multiple services to perform the entire job. The batch job is generally divided into tasks. Each task may be a portion of the overall batch job and each task may include a group of files, documents, or other instructions, that may be completed by a particular service.

Modem computing systems and networks provide for new and different kinds of work which are amenable to batch job processing. For example, the job of converting a group of word processing documents having the same format to an HTML format may be organized as a batch job. In this way, the user may simply specify a single set of parameters for converting all of the documents in the group, as opposed to performing the repetitious task of having to specify the same parameters for each and every document.

Batch jobs are to be contrasted with actions or commands in interactive applications which often require only a single function or key stroke to complete the entire job. For example, a “cut” or “paste” technique provided by a word processor program is one such command. Immediate feedback is possible with commands like cut or paste. After a user selects some text in a document, the cut operation is performed by a single press of a mouse button or function key on a computer keyboard. The user can immediately see the change to the document he is editing.

A batch job is more complex than single-function commands, because the batch job permits a variety of services to be combined. The individual tasks comprising the batch job are often different from one another, each requiring a different processing technique or function for completion. The various functions needed to perform the batch job may only be available from different sources. For example, several applications or programs may be necessary, some or all of which may be operating on different machines.

Currently, one way of preparing the batch job is to write a job program in a normal programming language. The program may enumerate a file directory, discover the type of each file and call an appropriate machine to carry out each task.

There are a number of disadvantages with the current preparation and execution of batch jobs.

First, a typical batch job program mixes the scheduling task, which machine to give each task to, in with the program logic of discovering file types and deciding what to do with each. This makes the programs difficult to write.

Second, the nature of most programming languages makes it difficult to mechanically analyze programs for validity before execution, to identify the state and progress of running programs in terms related to the overall task they perform, and to restart a program in the middle after a system failure.

Third, immediate results often cannot be obtained when the batch job is processed because of the number of different services which must be performed to process the various tasks.

Fourth, it is difficult to coordinate the sequencing of the services based on the various delays associated with performing each service. A typical program might have to run for minutes, hours, or days on a user's computer, particularly if a service requires human intervention or execution.

Fifth, the parallelizing of tasks of a batch job is not efficiently and easily done.

Therefore, it is desirable to produce a method and system for preparing and executing a batch job which solves the above disadvantages.

### SUMMARY

The present invention described roughly, includes a method and system for preparing and executing a batch job for execution by a batch job execution system, and in particular computer software for preparing and executing a batch job is provided.

According to one aspect of the present invention, a method for preparing a batch job for execution by a batch job execution system is provided. The method includes the steps of receiving a job from an external source, wherein the job includes at least one task; selecting a program, subsequent to receiving the job, which includes a first part and a second part, which may be used in executing the job; creating a batch job by associating the selected program with the job; and, transmitting the batch job to the batch job execution system.

In an embodiment, the first part of the program includes, among other things, at least one step, wherein each step identifies a service which is offered by the batch job execution system which can be used in executing at least a portion of one of the tasks of the batch job; and, the organization of the order in which each step may be performed by the batch job execution system, and whether the steps may be performed independent of one another and/or in parallel with each other.

According to an aspect of the present invention, the second part of the program is for executing at least a portion of one of the tasks of the batch job; and, is further capable of generating additional steps to be executed by the batch job execution system in order to complete the task being executed.

According to another aspect of the present invention, the program maybe selected by receiving a signal from the external source designating the program to be selected.

According to an alternative aspect of the present invention, the program may be selected by receiving a first signal from the external source which identifies the input type of information included in the batch job; receiving a second signal from the external source which identifies the desired output type of information to be obtained when the batch job has been executed; and, selecting a program based on the first and second signal.

According to an aspect of the present invention, a method for preparing a batch job for execution by a batch job execution system is provided. The method includes the steps of receiving a batch job comprising at least one task by a first part of the batch job execution system, wherein the batch job may be executed using a plurality of service providers; and, determining for each task of the batch job a service type, offered by a service provider of the batch job execution system, which may be used for performing the task. The method further includes, creating a step for each task, wherein each step comprises a first reference to the determined service type needed to perform the task; and, a second reference to the task. The next steps in preparing the batch job for execution are determining an efficient way to organize each of the created steps for execution by the batch job execution system; and, preparing a program which comprises each created step and the organization of each step for execution by the batch job execution system. The batch job and the program are then transmitted toward a second part of the batch job execution system.

In an embodiment, the step of determining a service type further comprises the step of, referencing a provider matrix which includes a list of services which are capable of being performed by the batch job execution system, and a list of service providers which are capable of performing each of the services.

According to still another aspect of the present invention, a method for preparing and executing a task of a batch job by a batch job execution system is provided. The method includes, receiving the task of the batch job which is to be executed by a service provider; making a call to start a session with a remote platform, in response to receiving the task; making a call to put, subsequent to making a call to start a session, which transfers at least a portion of the information in the task to be executed to the remote platform; making a call to convert, subsequent to making a call to put, which instructs the remote platform to perform a function on the information transferred to the remote platform; making a call to get, subsequent to making a call to convert, which retrieves the converted information from the remote platform; and repeating each step of making a call to put, convert and get until the task is completed. Once the task is completed the service provider makes a call to end the session with the remote platform.

According to another aspect of the present invention, a method for preparing and executing a task of a batch job by a batch job execution system is provided. The method includes receiving the task to be executed from a first portion of the batch job execution system by a second portion of the batch job execution system; and creating a plurality of steps which must be executed by a plurality of other service providers in order to complete the task. The next steps in the method are, sending the plurality of steps to be completed toward the first portion of the batch job execution system for execution; receiving a plurality of results from the first portion of the batch job execution system once the plurality of steps have been executed; and, preparing an output comprising the plurality of results.

According to yet another aspect of the present invention, a method for preparing a batch job for execution by a batch job execution system is provided. The method includes the steps of receiving a job from an external source, wherein the job may be executed using a plurality of service providers; selecting a first program, in response to receiving the job, which references a service provider of the batch job execution system, which offers a service of conversion planning; and creating a batch job by associating the selected first program with the job. Subsequent to creating a batch job the next step is transmitting the batch job toward the service provider which offers conversion planning.

The service provider which offers the service of conversion planning performs the steps of receiving the batch job; separating the batch job into a plurality of tasks, wherein each task may be performed by a separate service provider; determining for each task a service type, offered by a service provider, which may be used for performing the task; and creating a step for each task. Each step includes a reference to the service type needed to perform the task and a reference to the task. The next steps in performing the method are determining an efficient way to organize each step for execution by the batch job execution system; preparing a second program which comprises each step and the organization of each step for execution by the batch job execution system; and, sending the batch job and the second program to a job management apparatus.

According to another aspect of the present invention, an apparatus for preparing a batch job for execution by a batch job execution system is provided. The apparatus includes a client, which is capable of receiving a job from an external source, wherein the job includes at least one task; wherein the client is for selecting a program which comprises a first part and a second part, wherein the program may be used in executing the job; creating a batch job by associating the selected program with the job; and, transmitting the batch job toward the batch job execution system.

According to still another aspect of the present invention, an apparatus for preparing a batch job for execution by a batch job execution system is provided. The apparatus includes a service provider, for receiving a batch job comprising at least one task, wherein the batch job may be executed using a plurality of service providers; determining for each task of the batch job a service type, offered by a service provider with the batch job execution system, which may be used for performing the task; and, creating a step for each task. Each step includes, a reference to the determined service type needed to perform the task and a reference to the task. The service provider is also for determining an efficient way to organize each of the created steps for execution by the batch job execution system; preparing a program which comprises each created step, and the organization of each step for execution by the batch job execution system; and, transmitting the batch job and the prepared program toward a second part of the batch job execution system.

According to an aspect of the present invention, an apparatus for preparing and executing a task of a batch job by a batch job execution system is provided. The apparatus includes, a service provider which is capable of receiving the task of the batch job which is to be executed, wherein the service provider is for: (1) making a call to start a session with a remote platform, in response to receiving the task; (2) making a call to put, subsequent to making a call to start a session, which transfers at least a portion of the information in the task to be executed to the remote platform; (3) making a call to convert, subsequent to making a call to put, which instructs the remote platform to perform a function on the information transferred to the remote platform; (4) making a call to get, subsequent to making a call to convert, which retrieves the converted information from the remote platform; (5) repeating each step of making a call to put, convert and get until the task is completed; and, (6) making a call to end the session with the remote platform.

According to still another aspect of the present invention, an apparatus for preparing and executing a task of a batch job by a batch job execution system is provided. The apparatus includes a service provider, which is capable of receiving the task to be executed from a job management apparatus, wherein the service provider is for creating a plurality of steps which must be executed by a plurality of other service providers in order to complete the task; and, transmitting the plurality of steps to be completed toward the job management apparatus for execution. The service provider is also for receiving a plurality of results from the job management apparatus once the plurality of steps have been executed; and, preparing an output comprising the plurality of results.

According to an alternative aspect of the present invention, an apparatus for preparing a batch job for execution by a batch job execution system is provided. The apparatus includes, a client and a service provider of the batch job execution system, which offers a service of conversion planning, in communication with the client communication device. The client is for receiving a job from an external source, wherein the job may be executed using a plurality of service providers; selecting a first program which references the service provider; creating a batch job by associating the selected first program with the job; and, transmitting the batch job toward the service provider.

The service provider of the batch job execution system which offers conversion planning is for receiving the batch job transmitted by the client; separating the batch job into a plurality of tasks, wherein each task may be performed by a service provider of the batch job execution system; determining for each task a service type, offered by a service provider, which may be used for performing the task; creating a step for each task, wherein each step comprises a references to the service type needed to perform the task and a reference to the task; determining an efficient way to organize each step for execution by the batch job execution system; preparing a second program which comprises each step and information designating the organization of each step for execution by the batch job execution system; and, transmitting the batch job and the second program toward a second portion of the batch job execution system.

According to still another aspect of the present invention, an article of manufacture including an information storage medium wherein is stored information is provided. The article of manufacture includes a client communication software component. The client communications software component is for receiving a job from an external source; selecting a program software component which references at least one service provider software component; creating a batch job software component by associating the selected program software component with the job; and, transmitting the batch job software component to a service provider software component.

According to an aspect of the present invention, an article of manufacture including an information storage medium wherein is stored information is provided. The article of manufacture includes a service provider software component which offers conversion planning. The service provider software component which offers conversion planning is for receiving a batch job software component; separating the batch job software component into a plurality of tasks, wherein each task may be performed by a service provider software component of the batch job execution system; determining for each task a service type, offered by a service provider software component, which may be used for performing the task; creating a step for each task, wherein each step comprises a reference to the service type needed to perform the task and a reference to the task; determining an efficient way to organize each step for execution by the batch job execution system; preparing a program software component which comprises each step and information designating the organization of each step for execution by the batch job execution system; and, transmitting the batch job software component and the program software component to a portion of the batch job execution system.

Other aspects and advantages of the present invention can be seen upon review of the figures, the detailed description, and the claims which follow.

### BRIEF DESCRIPTION

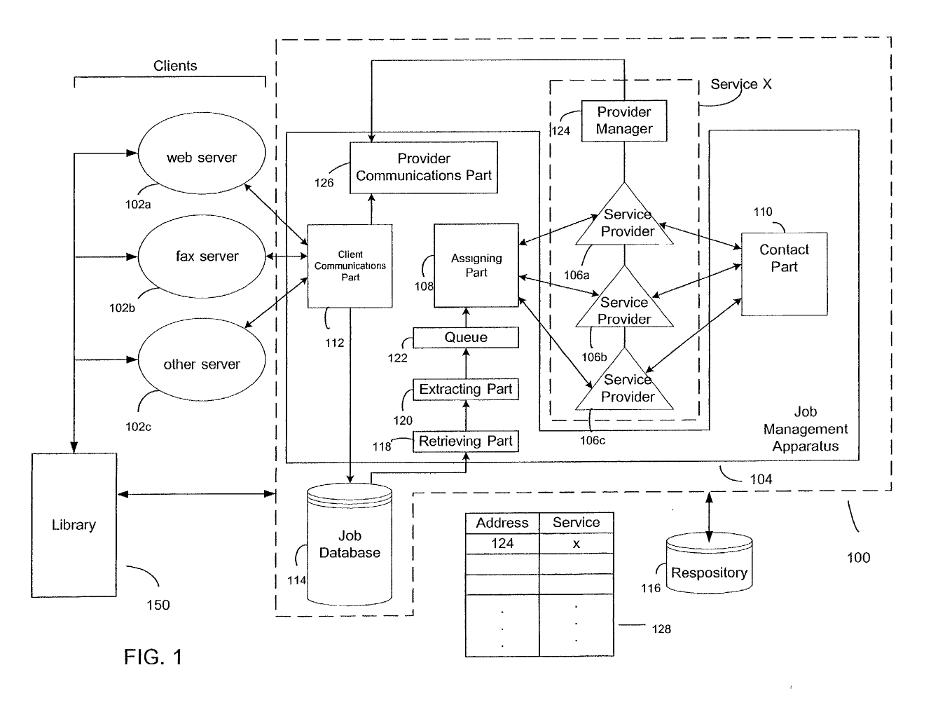

FIG. 1 is a generalized block diagram of a batch job execution system 100 constructed according to an embodiment of the present invention;

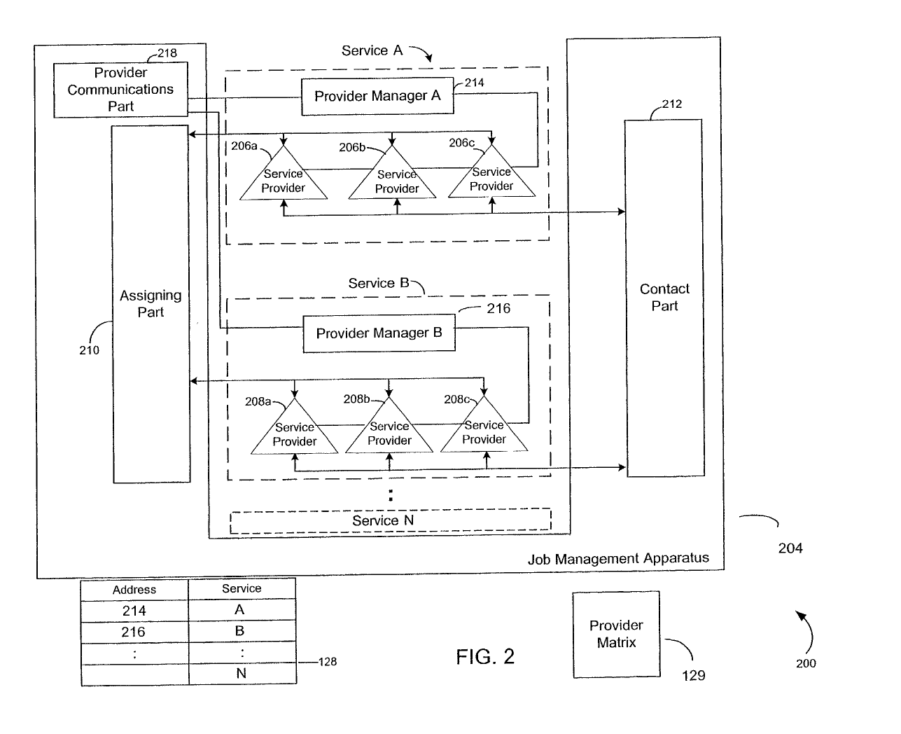

FIG. 2 is a generalized block diagram of a batch job execution system 200 constructed according to an embodiment of the present invention;

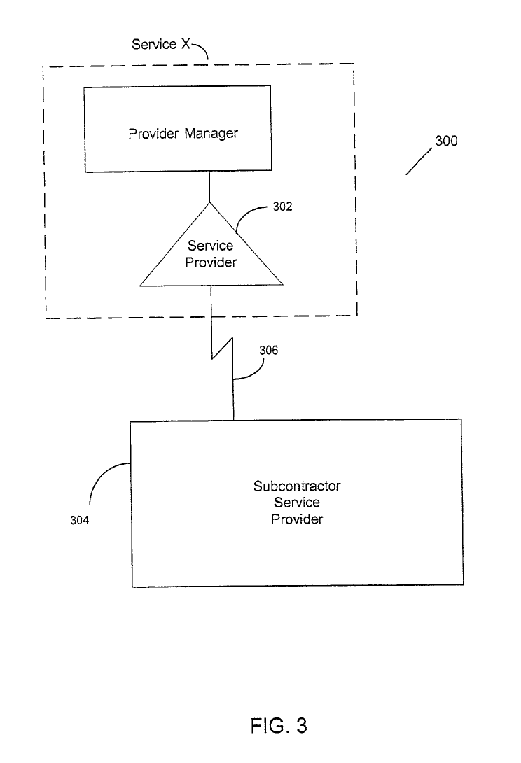

FIG. 3 is a generalized block diagram of a service provider in communication with a subcontractor service provider in a batch job execution system constructed according to an embodiment of the present invention;

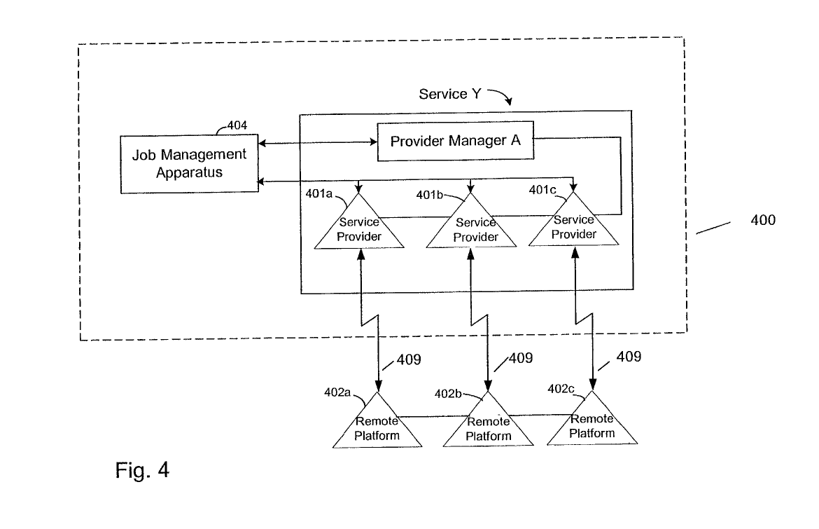

FIG. 4 is a generalized block diagram of a service provider in communication with a remote platform constructed according to an embodiment of the present invention;

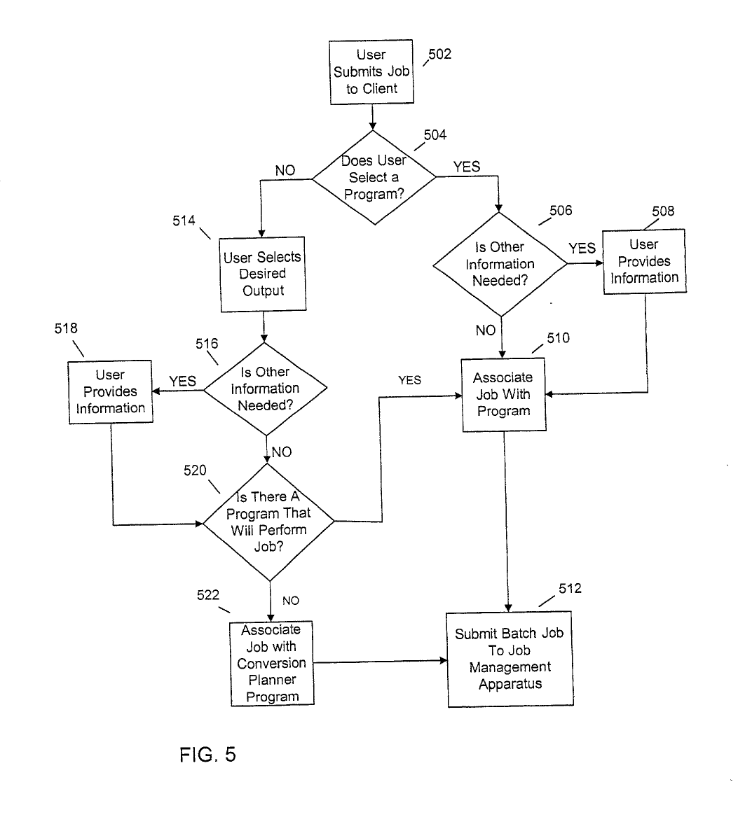

FIG. 5 is a generalized flow diagram illustrating a method of preparing a job and selecting a program for submission to a batch job execution system according to an embodiment of the present invention;

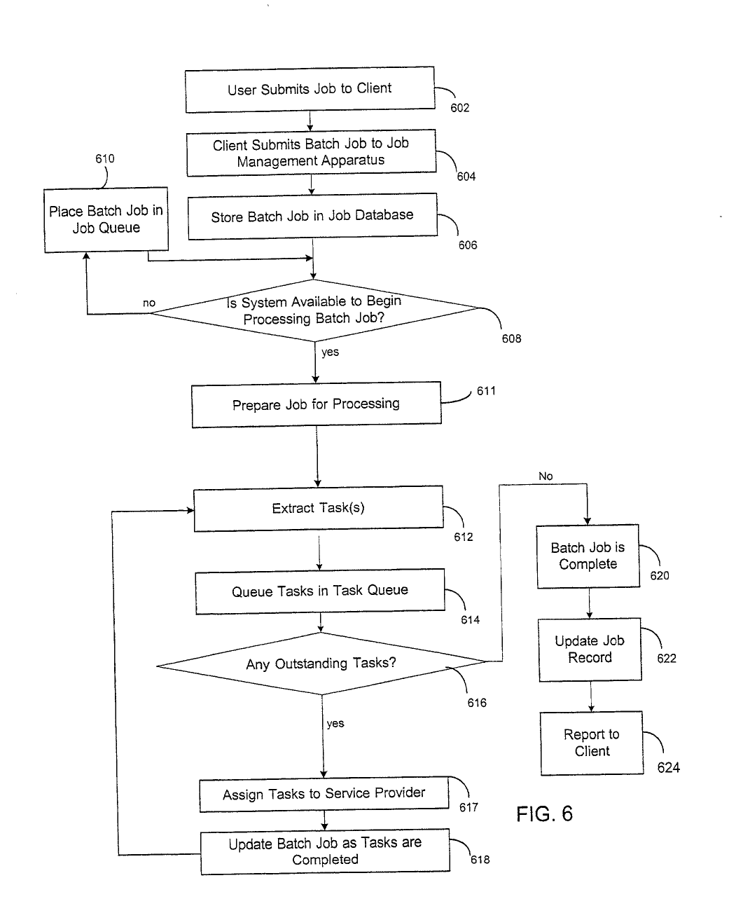

FIG. 6 is a generalized flow diagram illustrating a method of preparing a batch job for execution by a batch job execution system according to an embodiment of the present invention; and

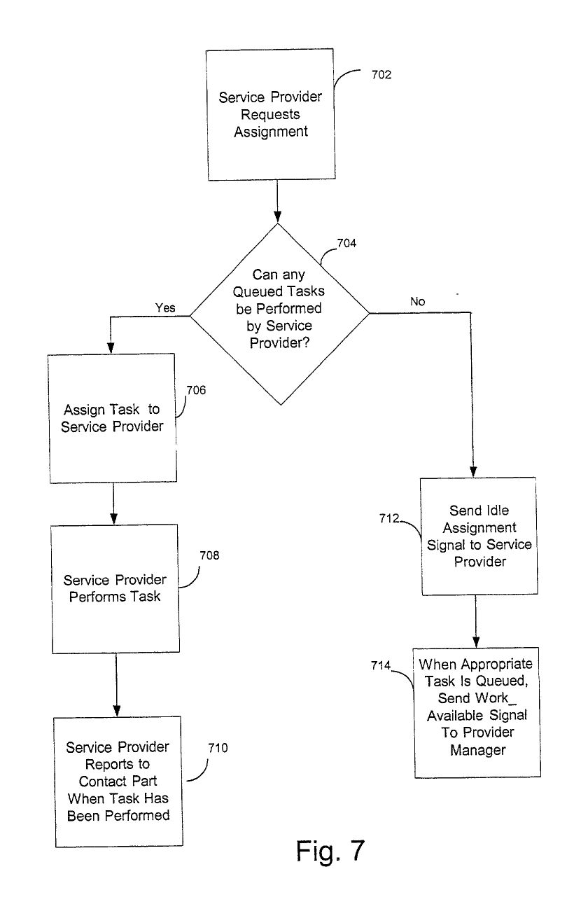

FIG. 7 is a generalized flow diagram illustrating a method of delegating tasks for execution by service providers in a batch job execution system constructed according to an embodiment of the present invention.

### DETAILED DESCRIPTION

FIG. 1 is a batch job execution system 100, according to an embodiment of the present invention. Batch job execution system 100 communicates with a plurality of clients 102a-102c. Batch job execution system 100 receives batch jobs from clients 102a-102c and performs the jobs for these clients. Batch job execution system 100 is compatible with a broad range of clients. For example, in FIG. 1, client 102a is a World Wide Web (“web”) server, client 102b is a facsimile transmission (“fax”) server, and client 102c is some other type of server. Clients 102a-102c each have interfaces for communication with users. For example, web server 102a has a graphical user interface comprising a set of web pages. The web pages are uniquely identifiable by Uniform Resource Locators (“URL”), so server 102a is easily accessible by a user operating a personal computer with a modem and Internet access software. Similarly, fax server 102b has a user interface to communicate with a user operating a personal computer or fax machine.

When a user submits a job for processing using one of the clients 102a-102c the user may upload a set of files or other documents and information that the work is to be performed on. In an embodiment, the user may select from the interface a program which includes parameters for breaking the job into specific tasks and assigning a step to each task which includes processing requirements for performing the job. In an alternative embodiment, the user, instead of selecting a program, may select the input type and the desired output by use of the interface. In yet another embodiment, the user may have the option to select either one of the programs or provide the input type and the desired output. In still another embodiment, the user may provide the input files and select the desired output and the client itself will determine the input type and select the appropriate program based on the information.

If the user selects the input type and the desired output and not a program the client in response will select an appropriate program for completing the job. The client then submits the job and the program which provides the information necessary to complete the job to the batch job execution system 100. The selected program and the job make up the batch job. In an embodiment, the job and the program may be transmitted to the job execution system 100 together. In an alternative embodiment, the job and the program may be transmitted independently. In each of these embodiments the execution of the batch job appears to be completely automated. The batch job may be transmitted over the Internet, cable line, via wireless communication, or other suitable transmission types.

In an embodiment, the program selected is one of multiple programs which are stored in a library 150. Each program in the library 150 represents the processing parameters used in performing a job by the batch job execution system 100. The library 150 is maintained on a suitable storage medium accessible by the batch job execution system 100 and the clients 102a-102c. In an embodiment, the library 150 is maintained on the same machine as part of the batch job execution system 100. In an alternative embodiment, the library 150 is maintained on one of the clients 102a-102c. In still another embodiment, the library 150 is maintained on an external source.

Each program in the library 150 may be divided into two parts: a declarative part and a procedural part. The declarative part allows scheduling and analysis to be done. This part includes a list of the steps to be performed and the tasks that are to be performed in completing the batch job. In an embodiment, the task may include a reference to the location of the files, documents or other instructions that make up the task. In an embodiment, each step identifies a service which is capable of performing the task associated with that step. Alternatively, multiple steps may be assigned to each task. The steps of a program contained in the library 150 are configured to provide efficient multi-step document conversion services. The program specifies the order of the steps to be done as part of a batch job in such a way as to allow each task to be reliably executed with maximum parallelism.

For example, a batch job may contain a set of Word files and a set of gif files, both of which are to be converted into HTML files. Such a job may have two tasks, one would include the Word files that are to be converted to HTML and the other would include the gif files that are to be converted to HTML. Since these tasks are independent of one another they may be performed in parallel. The step assigned to the first task would include information indicating that the task is to be assigned to a service which offers Word to HTML conversion. The step associated with the other task would include information indicating that the task is to be assigned to a service which offers gif to HTML conversion.

Also included in the declarative part is information about data dependencies between steps. For example, in some batch jobs the output of one task associated with a step is needed as the input for another. This means that the second step cannot be started before the first step has finished.

Using the above example, the batch job may further include the task of printing and mailing the converted HTML files. This task is dependent on the output of the first two tasks and thus cannot be performed until each has completed. The step associated with this task would include information indicating that the task is to be assigned to a service which offers printing of HTML files and mailing.

The declarative specification of steps and data dependencies simplifies various batch job execution system 100 operations. Parallel scheduling of tasks is simplified, along with advance program analysis and meaningful reporting of the progress of the job. Reliable execution is also simplified. Additionally, since the declarative part contains all the information necessary to start any step, the batch job execution system 100 can automatically restart any task associated with a step, should problems be encountered.

The procedural part of the program can be written in any programming language and carries out the arbitrary logic of the tasks. For example, a task may be to convert a Word file to a PDF file. The actual logic in performing the task might include converting the Word file to a Postscript file, followed by converting the Postscript file to a PDF file. In an embodiment, the procedural part is performed using a service provider which is capable of performing the particular function needed to perform the task. The procedural part does not need to know about the scheduling contained in the declarative part but can augment the set of steps to be performed. The procedural part of any individual task can specify additional steps that must be completed after this procedural part completes before the task is considered to have completed.

For example, a procedural part that converts the contents of a zip file to HTML may decompress and expand the zip file into four other files and return four steps to convert each of these files to HTML. These new steps are reported back to the job management apparatus 104 and become the next set of steps to be completed.

In FIG. 1, batch job execution system 100 includes a job management apparatus 104 which is responsible for communicating with clients 102a-102c and managing the execution of batch jobs submitted by the clients. This includes delegating each task of a batch job based on the order of the steps associated with each task and their interdependencies, to a plurality of independent service providers 106a-106c, and monitoring the progress of independent service providers 106a-106c in performing the tasks.

In an embodiment of the present invention, the job management apparatus and each of its associated parts may represent a software program, a software method, a software instance, a code fragment, a hardware operation or user operation, singly or in combination. As will be appreciated by one skilled in the art, the job management apparatus may be implemented by using one or a plurality of computers or servers in communication with one another.

In FIG. 1, job management apparatus 104 includes an assigning part 108 which communicates with the service providers 106a-106c. Assigning part 108 receives request_work signals from service providers 106a-106c and responds as described below. Other embodiments of job management apparatus 104 include additional assigning parts which are on the same or different servers from assigning part 108.

In FIG. 1, job management apparatus 104 further includes a contact part 110 to which the various service providers 106a-106c send signals to report on the status of work in progress. In other embodiments, additional contact parts are employed, some or all of which are on different servers than contact part 110. When additional contact parts are incorporated, each time a unit of work is delegated to a particular service provider, assigning part 108 identifies a specific contact part to which report messages should be sent in a response signal to the request for work.

In FIG. 1, job management apparatus 104 of batch job execution system 100 includes a client communications part 112 as an interface for communications with clients 102a-102c. Client communications part 112 receives batch jobs, requests, documents and other information from clients 102a-102c and sends signals to clients 102a-102c indicating the progress of a batch job.

In FIG. 1, batch job execution system 100 includes a job database 114. When a batch job is received from one of clients 102a-102c by client communications part 112, the job is stored in job database 114. The batch job stored in job database 114 includes various types of information and parameters including references to particular documents, the status of jobs, names and other information identifying clients 102a-102c, and options for performing jobs. Included in the information in job database 114 is the declarative part of the program which specifies the tasks that must be performed in completing a job.

The information stored in job database 114 is regularly updated as existing jobs are executed by batch job execution system 100 and new jobs are received. The presence of job database 114 is desirable to maintain a persistent and reliable record of the jobs as they are executed by job execution system 100. Other useful information may be stored within job database 114, as will be appreciated by the skilled artisan.

In FIG. 1, a repository 116 is also provided. The repository 116 is a database built on a file system or other suitable storage medium. The repository 116 may be situated on either the same computer or on a different computer than batch job execution system 100. Documents and other various files are stored in repository 116. When documents and files are submitted with a batch job by clients 102a-102c, these documents and files are stored in repository 116. Batch jobs, received by client communications part 112 from clients 102a-102c, often include information identifying one or more of the documents stored in repository 116. In one example, this information is a path name identifying the location of a particular document within the hierarchy of repository 116. When job management apparatus 104 manages the execution of various batch jobs and tasks of each, these jobs and tasks may use some of the same documents in repository 116 for processing, and may create new documents in repository 116.

In FIG. 1, job management apparatus 104 includes a retrieving part 118 which retrieves a batch job stored in job database 114 when the batch job is to be executed. An extracting part 120 extracts the individual tasks which comprise the batch job and queues these tasks in a queue 122 based on the organization of the steps in the program associated with the batch job.

In FIG. 1, independent service providers 106a-106c communicate with assigning part 108 and contact part 110 of job management apparatus 104. In the present embodiment, service providers 106a-106c all provide the same service, namely “Service X.” This service may be, for example, converting an HTML file to a MS Word file. In this way, service providers can be easily added and removed, and provider manager 124 can easily manage its various service providers.

In FIG. 1, service providers 106a-106c operate independent from one another and from job execution system 100. Service providers may “start” or “stop” operations without any involvement from job execution system 100. Thus, operation of job execution system 100 is simplified. That is, the job execution system need not determine when a particular service provider is available to perform work, or otherwise attempt to “push” tasks to the service providers. Nor does the job execution system need to actively monitor the service providers as they perform the tasks delegated by the job execution system. In an embodiment, the job execution system passively monitors the service providers by receiving status information which provide an update of the work being performed.

In FIG. 1, the various service providers 106a-106c are operating on different machines or computers while communicating with the job management apparatus 104 which operates on another machine. In another embodiment, job management apparatus 104 and service providers 106a-106c operate on the same machine, such as an Internet server. In different embodiments, various data networks are used to provide the connection between the service providers 106a-106c and job management apparatus 104, such as private networks and public networks like the Internet. In other embodiments, data networks including local area networks, frame relay networks, and ATM networks are used.

Service providers used with embodiments of the present invention take various forms. In one embodiment, one part of a service provider is a human. In another embodiment, a service provider is a program functioning as an interface for a human who performs part or all of a task. In yet another embodiment, service providers are programs running on computers.

In some embodiments, service providers interface with a plurality of job execution systems. For example, in FIG. 1, service provider 106c performs a French-to-English translation service for both batch job execution system 100 and another batch job execution system not shown in FIG. 1. Provider 106c performs multiple tasks for the various job execution systems using multiple threads or processes. To that end, any particular service provider used in an embodiment of a job execution system of the present invention may perform multiple tasks simultaneously using threads, processes, people, or other programs running on multiple computers.

In FIG. 1, a provider manager 124 is associated with the service providers 106a-106c. The provider manager 124 functions as a communications link between job management apparatus 104 and the service providers 106a-106c. In one embodiment, provider manager 124 is implemented on the same server as job management apparatus 104. In other embodiments, provider manager 124 is on the same server as one or more of service providers 106a-106c, or on a different server. The job management apparatus 104 instructs provider manager 124 as to which assigning part the service providers 106a-106c are to communicate with. In an embodiment, additional assigning parts may be implemented as part of the batch job execution system 100.

In FIG. 1, job management apparatus 104 sends control messages to provider manager 124 using provider communications part 126. For example, provider manager 124 can receive an “increase_capacity” signal from job management apparatus 104 indicating a backlog of work in the system. This condition arises when the rate at which service providers 106a-106c are sending request_work signals is slower than the rate at which tasks are being queued in queue 122, or when the number of jobs stored in job database 114 exceeds a certain threshold. Provider manager 124 may then create additional service providers to arrange to have some of the backlog work done. In other embodiments, provider manager 124 is in communication with other provider managers and essentially “drives” these managers. That is, provider manager 124 is configured to send signals to these other provider managers instructing them to have their associated service providers send request_work signals to assigning part 108.

If an increase_capacity signal is received from job management apparatus 104, provider manager 124 may respond with a signal indicating that provider manager 124 is already operating at full capacity. In an embodiment, service providers 106a-106c may send control messages to provider manager 124. For example, a service provider may send provider manager 124 a signal indicating that it

In FIG. 1, provider manager 124 is also useful when a service provider takes a task but fails to report back to job management apparatus 104 after some predetermined amount of time. After attempting to communicate with the particular service provider to determine the problem, provider manager 124 sends a signal to communications part 126 indicating that the service provider is still working on the task, or that the task should be reassigned to another service provider. Using the program and the step associated with the task, reassignment is easily done.

In alternative embodiments, provider manager 124 is used to stop the service providers from performing the tasks associated with a batch job. For example, after provider manager 124 has distributed tasks associated with a particular batch job to service providers 106a-106c, the user may signal web server 102a that he does not want the job done after all. This information is communicated through provider communications part 126 to provider manager 124 which signals service providers 106a-106c to stop working. Such is advantageous especially when the tasks involved are computationally complex and, therefore, time consuming. Service providers 106a-106c are immediately available to start working on tasks associated with other batch jobs.

In FIG. 1, provider manager 124 is identified in a registry 128 with other provider managers and indexed by a unique address. In some embodiments, Service X, the service provided by provider manager 124, is also provided by other provider managers identified in registry 128. In other embodiments, provider manager 124 is the only provider manager having associated service providers 106a-106c which offer Service X. In one embodiment, the registry is integrated with the job execution system, while in other embodiments, the registry is maintained by some external service. A provider manager registers by supplying its address, information describing the function it provides and, in some embodiments, other related information about the service providers associated with it. In other embodiments, the registry includes other information such as parameters used by the various service providers associated with the respective provider managers.

FIG. 2 is a generalized block diagram of a batch job execution system 200 constructed according to another embodiment of the present invention. Job execution system 200 is similar to job execution system 100 in some respects, but system 200 is different due to the number “N” of various services provided, as well as the configuration of service providers. The N services are different from one another, providing a broad range of services so job execution system 200 can service many different batch jobs.

In FIG. 2, a job management apparatus 204 includes an assigning part 210 which functions similar to assigning part 108 of FIG. 1. A first plurality of service providers 206a-206c are associated with Service A, a second plurality of service providers 208a-208c are associated with Service B, and so on. Thus, by providing multiple service providers performing the same functions, it is more likely that at least one of service providers 206a-206c will be sending request_work signals to assigning part 210 at any given time. In this way, assigning part 210 can immediately delegate tasks queued in queue 122 (FIG. 1) to the requesting service provider, reducing the likelihood of a backlog of work developing. Additionally, if multiple steps having tasks which require the same function and are independent of one another, they may be executed in parallel.

In FIG. 2, some of the service providers operate on different machines from one another. This is because job execution system 200 imposes no constraints on the nature of service providers which can request work from job execution system 200. Batch job execution system 200 supports a variety of service providers. In one example, service provider 206a operates on a UNIX machine, and service provider 206b operates on a Windows NT machine. In another example, service providers 206a-206c operate on the UNIX machine, and service providers 208a-208c all operate on the Windows NT machine. In yet another example, service provider 208a operates on the same machine as service provider 206a, service provider 208b operates on the same machine as service provider 206b, and so on.

In FIG. 2, the service providers communicate with assigning part 210 to receive work from job management apparatus 204. Other embodiments include additional assigning parts which are on the same or different servers from assigning part 210. In one example, one assigning part is on a UNIX machine with one service provider, and other assigning parts are on Windows NT machines with other service providers. When additional assigning parts are implemented as part of batch job execution system 200, job management apparatus 204 instructs provider managers 214 and 216 as to which assigning part the service providers associated with the respective provider managers are to communicate with.

In FIG. 2, job management apparatus 204 further includes a contact part 212 with which the various service providers communicate. In other embodiments, additional contact parts are employed. For example, some contact parts are on UNIX machines, and other contact parts are on Windows NT machines. These may be the same machines on which various service providers are operating, or they may be networked to these machines over any data network such as a local area network or the Internet.

In FIG. 2, a first provider manager 214 is associated with service providers 206a-206c. A second provider manager 216 is associated with service providers 208a-208c, and so on. Each provider manager functions similar to provider manager 124 in FIG. 1 in managing communications between the respective service providers and provider communications part 218. As with the provider manager 124 of FIG. 1, provider managers 214, and 216 in system 200 are also identified in a registry 128.

In FIG. 2, each service provider may be identified in a provider matrix 129 with other service providers. The provider matrix 129 is maintained on a suitable storage medium accessible by the batch job execution system 200. In an embodiment, the provider matrix 129 is maintained on the same machine as part of the batch job execution system 200. The provider matrix 129 contains information about possible conversions capable of being performed by the job execution system 200. Each cell within the provider matrix 129 represents a disjunction of possible service provider calls that will achieve a particular conversion. In an embodiment, each element of the disjunction is a sequence, where each element of the sequence contains the name of a service provider to be called, along with information about the parameters with which the service provider should be called. In an embodiment, an element of the sequence also contains information about the service provider's quality.

In an embodiment, Service A, the service offered by service providers 206a-206c may also be offered by other service providers which are identified in provider matrix 129. In other embodiments, service providers 206a-206c are the only service providers which offer Service A.

As the number of services offered by the batch job execution system 200 increases the list of programs in library 150 and offered by a client may not contain every possible job that may be performed. In an embodiment, a user instead of selecting a program, may select an input type and the desired output type along with other parameters needed to perform the job. In an alternative embodiment, the user may submit the files or documents that work is to be performed on and select the desired output along with other parameters needed to perform the job. In each embodiment, this is all that the user need do. The rest of the process of performing the job appears to be automated to the user.

If there is no program in the library 150 which will perform the job, the job is submitted by the client to the job management apparatus 204 with a program that identifies a service which offers conversion planning. The job management apparatus 204 in executing the job will perform as it would with any other job submitted by a client. The job management apparatus 204 following the step of the program submits the entire job to a service which offers conversion planning.

The conversion planning service receives the task which is a batch job, from the job management apparatus 204 and creates a program similar to the programs in library 150 which, when completed, will perform the job. In creating the program the conversion planner determines each of the tasks that must be completed and references the provider matrix 129 to determine an efficient way to organize the execution of each step to be associated with the tasks. The conversion planner will submit a new program and the job to the job management apparatus 204. The program is similar in structure to the other programs listed in library 150. The program will include, among other things, each step and all dependency information necessary to perform the job.

The job management apparatus 204 will receive this program and job and perform the job as if it had been submitted by a client, as described above. The use of a conversion planner simplifies the operation of the job management apparatus 200 by removing the need for the job management apparatus 200 to plan an efficient way to perform a job.

One of the services of batch job execution system 200 in FIG. 2 may provide the service of “forking and gathering,” which organizes the output results being returned to the job management apparatus 204 by the different service providers. Once organized the results may be delivered to the user when the job is completed. Additionally, because the job execution system 200 performs jobs in a series of steps, tasks associated with intermediate steps may produce output documents that are not destined for the output collection. The service of forking and gathering may be added at the end of a job as an additional step to gather and organize the desired output files and submit them to the user.

In addition to organizing the output of tasks in a batch job a service which provides forking and gathering may efficiently assist in converting documents. Some of the batch jobs submitted to batch job execution system 200 may include compound documents, consisting of a number of document segments. These segments often must be processed separately by separate service providers, thereby creating multiple documents from one input document.

For example, scanning a multi-page document on a document scanner could produce a single file consisting of multiple page images in the TIF file format. If the task to be performed was to display these images on the World Wide Web, the individual pages of the file must be extracted or “forked” into individual segments which are to be converted into individual JPEG format files, one file per page. These files, once they have been converted by the respective service providers and returned to the job management apparatus 204 must be “gathered” into a single HTML file which contains every JPEG page image. The forking and gathering service may perform these steps.

A service provider which offers this service would be referenced by the step associated with such a task. The task would be sent to the service provider by the job management apparatus 204, just as any other task. The service provider would then break the file into its segments and return a series of additional steps to the job management apparatus that must be performed on the segments, and a final step which returns each converted segment back to that service provider. Subsequent to the processing of each step the converted files are returned to that service provider for combining each into a HTML file format. The service provider then sends a task_complete signal to the job management apparatus 204 indicating that the task is complete.

In another example, a user may input one file and desire multiple files as output. This job will be executed using the above described methods. Once each of the desired output files have been created from the input file by each of the service providers the final step in the job would call a service which provides the service of gathering. This service provider would locate each of the desired output files and bundle them in an organized fashion to be delivered as requested by the user.

A service which offers forking and gathering of documents simplifies the operation of the job management apparatus 204. Additionally, such a service may be used to provide an organized output of information to be delivered to the user upon completion of a job.

FIG. 3 is a generalized block diagram of a service provider 302 in communication with an external subcontractor service provider 304 in a batch job execution system 300 constructed according to an embodiment of the present invention. In an embodiment, service provider 302 operates on a UNIX machine and interfaces with a job management apparatus similar to the service providers described above with respect to FIGS. 1 and 2. Service provider 302 communicates with subcontractor 304 over any data network 306 such as the Internet.

In one example of FIG. 3, subcontractor 304 is a “print shop” which provides a printing service for documents sent to service provider 302. In another example, subcontractor 304 is a translator which translates the document from one language to another. Service provider 302 receives documents for translation from the job management apparatus and sends the documents to the subcontractor 304 for translation by human translators. After translation, subcontractor 304 sends the translated documents to some designated recipient, or sends the translated documents back to service provider 302 which may report these results to a user.

FIG. 4 is a block diagram of an embodiment of a service Y which may be offered by a batch job execution system 400. Batch job execution system 400 operates in a similar fashion to the batch job execution system 100 of FIG. 1. Service Y, offered by batch job execution system 400, running on a UNIX system, provides the function of converting Windows based documents by use of a remote Windows platform. The service providers 401a, 401b, and 401c communicate with job management apparatus 404 in the same fashion as independent service providers 106a, 106b, and 106c of FIG. 1, as described above. The various service providers 401a-401c may be operating on different machines or computers while communicating with the job management apparatus 404 which operates on another machine. In another embodiment, job management apparatus 404 and service providers 401a-401c operate on the same machine, such as a UNIX machine.

In an embodiment, the service providers 401a-401c of service Y provide the service of converting a UNIX text file to a Windows text file. When such a task is submitted to one of the service providers 401a-401c by the job management apparatus 404 the selected service provider begins processing the job by sending a start_session message which creates a unique session identification between the service provider and a remote service 402a, 402b, or 402c. The remote service 402a-402c are operating on a machine separate from those of the batch job execution system 400. In another embodiment, remote services 402a-402c may be operating on a machine which offers additional services in batch job execution system 400. In an embodiment, remote services 402a-402c operate on a Windows based platform. The remote services 402a-402c may be either all on one machine or operating on separate machines. Service providers 401a-401c communicate with remote services 402a-402c over any data network 409, such as the Internet.

Once a session identification is established the service provider submits a number of calls to “put,” which sends the file to be converted to the remote platform. Once the remote platform has received the file the service provider submits a call to “convert.” This call actually causes the work of conversion to happen in the service running on the remote platform. The call to convert takes parameters from the procedural portion of the program associated with the task which describes the details of the work to be done, such as what format to convert the file into, and makes the calls on the appropriate Windows application.

After the file has been converted the service provider submits a call to “get,” which obtains the result of the conversion process. Once the result has been obtained the service provider sends an “end session” to the remote service thereby terminating the link and removing the unique identification address.

The service provider, after performing the task on the remote platform sends a task_complete signal to the job management apparatus 404 in the same manner as all other service providers.

For example, service provider 401a operating on a UNIX system may initiate a session with a remote platform 402a operating on a Windows system by establishing a unique identification address. Service provider 401a may submit a call to “put” a page image file to the remote platform. This file is to be converted to text using optical character recognition software (hereinafter referred to as “OCR program”). Once the file has been transferred to the remote platform service provider 401a will submit a call to “convert,” which will instruct the OCR program, which is running on the remote platform, to 1) read the page image file; 2) perform character recognition on the image; and 3) write a text file containing the recognized characters. Service provider 401a will then submit a call to “get” the text file, and then send a call to end the session thereby terminating the identification address and ending that session. Once service provider 401a has received the text file from the remote platform it will send a task_complete signal to the job management apparatus 404 and store the converted file in the repository 116.

Allowing the service providers 401a-401c of service Y to communicate with remote platforms independent of batch job execution system 400 reduces the workload of the job management apparatus 404.

FIG. 5 is a generalized flow diagram illustrating a method of receiving a job from a user and selecting a program to be associated with the job for submission to job management apparatus 104 according to an embodiment of the present invention.

As one who is skilled in the art would appreciate, FIGS. 5, 6, and 7 illustrate logic steps for performing specific functions. In alternate embodiments, more or fewer logic steps may be used. In an embodiment of the present invention, a logic step may represent a software program, a software object, a software function, a software subroutine, a software method, a software instance, a code fragment, a hardware operation or user operation, singly or in combination.

In an embodiment of the present invention, batch job execution system and the clients illustrated by FIGS. 1 and 2 are stored in an article of manufacture, such as a computer readable medium. Fox example, batch job execution system and/or clients may be stored in a magnetic hard disk, an optical disk, a floppy disk, CD-ROM (Compact Disk Read-Only Memory), RAM (Random Access Memory), ROM (Read-Only Memory), or other readable or writeable data storage technologies, singly or in combination.

The method illustrated in FIG. 5 is described with reference to FIGS. 1 and 2. In step 502, a user submits a job to one of the clients 102a-102c. In submitting the job the user may upload documents, files and/or other information which is to be processed during batch job execution.

In step 504, the client 102a-102c determines whether the user submitting the job has selected a program from a menu which is provided to the user through an interface. If a program is selected, in step 506, the client by referencing the program determines whether additional information is needed to perform the job. Such additional information may include, addresses for mailing results of the program, or other similar type information.

In step 508, if the client determines that additional information is needed to perform the job in step 506, the client will request that the information be provided.

In step 510, if no additional information is needed for processing the job in step 506, or if the additional information has been submitted to the client in step 508 the client prepares a batch job by associating the program that has been selected with the job.

In step 512 of FIG. 5, the client 102a-102c that has received the information from the user submits the batch job to the job management apparatus 104.

In step 514, if it is determined that the user did not select a program from the menu in step 504, the client will request that the user select a desired output for the job. In an embodiment, the user may additionally be asked to provide the input type information for the job. In still another embodiment, the client may determine the input type information based on the input documents that it has received.

In step 516, a client requests a determination from the user if additional information is needed to perform the job. This information is similar to the information that may have been provided in step 508. If additional information is needed the user, in step 518 will submit the needed information.

In step 520, the client determines if there is a program located in the library 150 that is capable of performing the desired job requested by the user. This determination is made by the client based on the input files and the desired output selected by the user. If it is determined that such a program exists control is passed to step 510.

As discussed above, in step 510 the client prepares a batch job by associating the program that is capable of performing the job with the job and the process completes as previously described.

If it was determined in step 520 that there is no program in the library 150 capable of performing a desired job, control is passed to step 522.

In step 522, the client prepares a batch job by associating a program with the job which calls a service that provides conversion planning. This batch job is submitted to the job management apparatus 104 as previously described in step 512.

FIG. 6 is a generalized flow diagram illustrating a method of preparing a batch job for execution by batch job execution system 100 according to an embodiment of the present invention. The method illustrated in FIG. 6 is described with reference to batch job execution system 100 of FIG. 1. In step 602, a user submits a job to one of clients 102a-102c. The user also selects a program or provides the input and desired output and any processing parameters needed to perform the job.

In step 604 of FIG. 6, the receiving client prepares a batch job comprising the job and the program and passes the batch job to client communications part 112 of job management apparatus 104. In step 606, the batch job is stored in job database 114. Before proceeding further, in step 608, job management apparatus 104 determines whether the job execution system 100 is able to process the newly received batch job. In some rare instances, job execution system 100 may not be ready to begin processing if, for example, the system is very close to its resource limits. If job execution system 100 is not ready, in step 610 the batch job is held in a job queue and control returns to step 608. In an alternative embodiment, the batch job is simply left in job database 114 as control returns to step 608. When job execution system 100 becomes available for processing, retrieving part 118 retrieves the batch job from the queue or job database 114, and prepares the job for processing in step 611.

In step 612 of FIG. 6, one or more tasks are extracted by extracting part 120 from the batch job in accordance with the steps provided in the associated program.

In step 614 of FIG. 6, the extracted tasks are queued in queue 122. The tasks are queued for efficient execution with parallelism based on the program associated with the job.

In step 616, assigning part 108 determines whether there are any existing tasks in queue 122 that have not been executed. If there are outstanding tasks, in step 616 control is passed to step 617.

In step 617, each outstanding task is executed by referencing the associated step of the program which includes information as to what type of service will perform the task. Based on the information the task is assigned to an independent service provider upon receiving a request for work from the independent service provider that it can perform such a service. In this way, minimal information is exchanged between job management apparatus 104 and the service providers, and maximal independence of the service providers is preserved.

In step 618, as the batch job is executed, status information regarding the batch job, stored in job database 114, is updated. In some embodiments, this information is made available to the clients 102a-102c so the user can monitor the status of the job as it is executed.

As tasks are completed, any pending tasks having steps which are dependent on completed steps can be loaded into the queue for processing. Multiple pending tasks may be queued and executed in parallel if their associated steps are not dependent on each other, using multiple service providers.

In step 616 of FIG. 6, if there are no outstanding tasks queued in queue 122, this indicates that all of the tasks of the batch job have been completed, as shown in step 620. Status information regarding the batch job is updated to reflect that the job has been completed, in step 622. In some embodiments, client communications part 112 then sends a signal to clients 102a-102c indicating that the job is complete and communicates any additional information regarding the executed batch job in which the user may be interested, for example, the time of completion, cost, delivery information and other information. In other embodiments, the user requests information regarding the executed batch job from the system through clients 102a-102c. In step 624, this information is reported to the clients 102a-102c which may in turn report to the user.

FIG. 7 is a generalized flow diagram illustrating a method of delegating tasks of a batch job for execution by service providers according to an embodiment of the present invention. The method illustrated in FIG. 7 is described with reference to batch job execution system 100 of FIG. 1. In step 702 of FIG. 7, a service provider requests work by sending a request_work signal to assigning part 108 of job management apparatus 104. Generally the service provider sends the request_work signal only when that service provider is available to perform work. In this way, the job execution system need not “start” a service provider or some other software or hardware to force the service provider to perform the tasks needed to complete the job. This improves the efficiency of job execution system 100, as job management apparatus 104 does not need any information that would otherwise be required to drive the service providers. This, in turn, maximizes the independence of job management apparatus 104 because there are no constraints on the types of service providers which may be used and interchanged with one another.

The request_work signal identifies the requesting service provider by a name assigned to it by job management apparatus 104, and the signal specifies a particular type of function or service which that service provider performs. The request_work signal also contains other information such as the identity of provider manager 124 to which control messages may be sent, and the minimum frequency at which progress reports should be expected from that service provider.

In some embodiments, when service providers performing the same function request work from job management apparatus 104, the job management apparatus allows the competing service providers to bid for the work. Based on the results of the bidding, assigning part 108 then delegates the task to the appropriate service provider. In an alternative embodiment, the job management apparatus simply arranges a priority to assign the work to one particular service provider whenever a conflict arises.

In step 704 of FIG. 7, responsive to receiving the request_work signal, assigning part 108 of job management apparatus 104 determines whether any of the tasks in queue 122 require a service corresponding to the function specified by the service provider in the request_work signal. Instep 706, if a task in queue 122 can be performed by the requesting service provider, the task is assigned to that service provider and sent to the service provider for processing. The declarative portion of the step associated with each task includes a unique identifier for that assignment.

The declarative portion of each step further includes a complete description of the work to be performed. Specifically, the type of operation that the service provider is to perform on the task is identified. Depending on the particular batch job, this may include validating the task, estimating the time or cost for completing the task, preparing a bid for the task, or performing the task. Other special instructions are included pertaining to the type of operation requested and processing constraints such as maximum cost. The declarative part also includes references to any resources needed to perform the particular task involved, such as specific files in a repository, and delegations of authority to access those resources or perform other operations.

In FIG. 7, upon receiving the task in step 708, the service provider performs the task. While the task is being executed, the service provider sends status_report signals to contact part 110 to indicate how much of the task has been performed, and the estimated time remaining to complete the task. The status_report signal includes information identifying that particular service provider and the particular task being executed.

In step 710 of FIG. 7, the service provider sends a task_complete signal to contact part 110 of job management apparatus 104 when the service provider has performed the task delegated to it by job management apparatus 104. Output results from processing the task are also returned to contact part 110, so job management apparatus 104 may coordinate these results with results from other task assignments and handle as designated by the user. Output results are stored as files in a repository or recorded in the memory of a computer with other data structures. The output results may also include a bill of charges from the service provider to the job execution system.

In FIG. 7, upon receiving the task complete signal from the service provider, job management apparatus 104 recognizes that the particular task delegated to that service provider has been performed. In one embodiment, where remaining tasks have not been extracted from the batch job, extracting part 120 extracts the task associated with the next step in the program from the batch job and queues the task in queue 122. In other embodiments where all the tasks comprising the batch job have been extracted, job management apparatus 104 determines which tasks, if any, have not been performed. After all of the tasks have been performed, job management apparatus 104 dispenses the output results of the batch job as designated, or alternatively may submit the results to a service which provides forking and gathering, as described above.

In step 704 of FIG. 7, if there are no tasks in queue 122 which can be performed by the requesting service provider when the request_work signal is received, assigning part 108 records the name of the particular service provider which requested work and the services that service provider performs. In step 712, assigning part 108 then sends an idle_assignment signal to the service provider. In one embodiment, upon receiving the idle_assignment signal, the service provider stops sending request_work messages to the assigning part. In another embodiment, the service provider continues to send request_work messages to assigning part 108 until the service provider receives a task.

Later, when a task capable of being performed by the requesting service provider is queued in queue 122, in step 714, assigning part 108 sends a “work_available” signal to provider manager 124 indicating that a task, appropriate for the particular service provider which received the idle_assignment signal, is queued in queue 122. The provider manager then signals the service provider which received the idle_assignment signal that work is available. If the service provider is available, the service provider resumes sending request_work messages to assigning part 108. The idle_assignment feature reduces the time and costs associated with the service provider repeatedly sending request_work messages to a job management apparatus having no tasks available to delegate.

Some exemplary service providers used with batch job execution systems constructed according to an embodiment of the present invention have the ability to adjust their capacities, such as by changing the number of people on duty to provide a particular function. When a backlog condition arises, as described above, job management apparatus 104 sends an “increase_capacity” signal to provider manager 124 indicating that a backlog is developing and specifying the size of the backlog. The increase_capacity signal also identifies a particular assigning part 108 to which request_work signals should be sent. Provider managers then respond by taking the necessary steps to increase their capacity, such as increasing the number of service providers running simultaneously. Some provider managers simply reply with an indication that capacity cannot be increased.

A service provider to which a task has been assigned may fail to complete the task. Such may occur, for example, if the machine on which the service provider is operating shuts down. In this situation, the service provider preferably sends a “task_incomplete” signal to contact part 110 of the job execution system. Assigning part 108 of job management apparatus 104 then redistributes the task, which the particular service provider failed to complete, to another service provider upon request.

In some embodiments, the job management apparatus interacts with the service provider for some control purpose such as interrupting the processing of a task. Such may be desirable, for example, when the job management apparatus does not receive a status_report signal from the provider for some predetermined period of time. The lack of any status report suggests that the service provider has stopped performing. In this case, the job management apparatus sends one of a variety control signals to the provider manager associated with the service provider in question.

In one example, an “abort assignment” signal is sent by the provider communications part to the provider manager when work in progress should be stopped. The abort_assignment signal includes information identifying the particular task involved and the name of the service provider that received the assignment. The assigning part of the job management apparatus then redistributes the task which the particular service provider failed to complete to a different service provider, upon request from the different service provider.

In another example, when no status_report signal has been received from a particular service provider by the contact part for some predetermined period of time, the provider communications part sends a “report_now” signal to the provider manager to request an immediate report. When no status report is received after the report_now signal is sent, the job management apparatus redistributes the task to a different service provider upon request The provider communications part then sends a “provider_abandoned” signal to the provider manager indicating that the job management apparatus has assigned the work elsewhere, so the service provider can stop working on the assignment. In some embodiments, no new assignments will be given to the service provider which failed to provide the status report.

### EXAMPLES

Batch job execution systems constructed according to an embodiment of the present invention use as fully as possible all of the processing resources available. A variety of services are provided for batch jobs having individual tasks which have widely varying execution requirements. For instance, some tasks may require a program available on only a UNIX machine, while others require a commercial application running on a Windows NT machine. Other tasks require printing services from a print shop operating at a different site than where the job management apparatus and other service providers are operating. Still others require the services of human experts who function on their own schedules.

The following examples refer to the systems shown in FIGS. 1, 2, and 3 by way of illustration. In these examples, a user has Internet access software operating on a personal computer. In an embodiment, the user simply dials the number of a local Internet service provider over a public switched telephone network (“PSTN”) using a modem. A communications path is established over the PSTN between the personal computer with the Internet service provider. In another embodiment, the user has a direct connection to the Internet. The user then accesses web server 102a through the Internet service provider.

Upon accessing web server 102a, the user then transmits or “uploads” a job which may include a number of computer files or documents to web server 102a using a file upload function of his Internet access software. The user then selects a program from a menu of options from the interface and specifies parameters needed for processing abatch job. After delivering the file to web server 102a, the user does not need to concern himself with the management and execution of the job.

In a first example, the user desires that batch job execution system 100 correct grammar and spelling in a letter and mail a hard copy of the corrected letter to some designated person. The user submits the letter electronically to web server 102a in a generic text format. The user then selects a program from the menu which performs the job of correcting grammar and spelling in a letter and mailing a hard copy of the corrected letter to some designated person. The user also specifies an address to which the letter will be delivered. Web server 102a passes the information as a batch job, including the program for performing the job to client communications part 112. Job execution system 100 is available to begin processing the work immediately, so the batch job is passed to extracting part 120.

The program sent as part of the batch job includes three steps in the declarative portion. The first step, which is associated with the task of spell check and grammar check will include information specifying the service type that the task must be distributed to. The second step, which is associated with the task of document conversion will include information specifying the service type that the task must be distributed to. The third step, which is associated with the task of printing and delivering will include information that a service which performs this task must be selected. Also included in the declarative portion of the program is information that each of the three steps depend on the output of the previous step and therefore must be distributed in order. Each type of service is identified based on the request_work signal that each service provider sends.

Using the program sent by the client as part of the batch job, extracting part 120 breaks the batch job into three successive tasks: (i) grammar check and spell check the document, (ii) convert the document from text format to a printable encoding such as Postscript, and (iii) print and deliver a hard copy of the document to the address specified by the user. These tasks are queued in queue 122 in the order specified by the program.

Referring to FIG. 2, service providers 206a-206c, operating on Windows NT machines, provide spell check and grammar check applications. Service providers 208a-208c provide document format conversion services, also using software applications operating on Windows NT machines. A third group of service providers cooperates with a print shop subcontractor 304, as shown in FIG. 3, for printing and delivery services.

Service provider 206a sends a request_work signal to assigning part 210. Assigning part 210, recognizing that this service provider can perform the task associated with the first step sends the document to service provider 206a for processing. The service provider performs the procedural portion of the program associated with that task which is checking the document for grammar and spelling errors and making any necessary revisions. Once this is completed service provider 206a sends a task_complete signal to contact part 212. Based on the task_complete signal, the job management system based on the declarative part of the program queues the next task to be performed into queue 122 When service provider 208a subsequently sends a request_work signal to assigning part 210, the corrected document is sent by assigning part 210 to service provider 208a for format conversion. Service provider 208a then perform the procedural portion of the program associated with that task by encoding the document as Postscript and returning the Postscript file to contact part 212.

After the document has been corrected and encoded, when assigning part 210 receives a request_work signal from one of the third group of service providers, the encoded version of the document is sent to this service provider with the shipping address. The document is then sent by this service provider to print shop subcontractor 304 for printing and delivery. The document is delivered by any commercially or publicly available delivery service to the designated recipient.

In a second example, service providers 206a-206c provide electronic document format conversion from Microsoft Word to Corel Word Perfect. Service providers 208a-208c include human translators who translate Corel Word Perfect documents from English to French and correct style as needed. A third group of service providers are print shops which handle printing and delivery of Corel Word Perfect documents. In this example, the user wants to receive the French documents and also wants to print and deliver the documents.

The user submits an input electronic document in Microsoft Word format written in the English language to batch job execution system 100 through web server 102a. The user desires the output document to be in Corel Word Perfect format written in French, so the user sends web server 102a information identifying Word Perfect 8.0 and French as the desired output. The user also specifies the format of the input document as Microsoft Word 8.0 in a similar manner. In other examples, the system 100 is capable of automatically detecting the format of the input document. The web server 102a in response to the information selects a program that can perform the particular job. The job and the program are then transmitted to the job management apparatus 104.

The program sent as part of the batch job includes three steps in the declarative portion. The first step, which is associated with the task of document conversion will include information specifying the service type that the task must be distributed to. The second step, which is associated with the task of translation will include information specifying the service type that the task must be distributed to. The third step, which is associated with the task of printing and delivering will include information that a service which performs this task must be selected. Also included in the declarative portion of the program is information that each of the three steps depend on the output of the previous step and therefore must be distributed in order. Each type of service is identified based on the request_work signal that each service provider sends.

Using the program sent by the client as part of the batch job, extracting part 120 breaks the batch job into three successive tasks: (i) convert the document from Microsoft word format to Corel Word Perfect format, (ii) translate the document from English to French and correct style as needed, and (iii) print and deliver a hard copy of the document. The French document is also tagged as the result document to be returned to the user. These tasks are queued in queue 122 in the order specified by the program.

A first task is extracted from the batch job and queued in queue 122. The first task is document format conversion. In FIG. 2, when service provider 206a sends a request_work signal to assigning part 210, the first task is sent to service provider 206a. The document is converted to WordPerfect format and returned to contact part 212. Then, a second task in the batch job is extracted by the extracting part and stored in the queue. The second task is language translation from English to French. Upon receiving a request_work signal from service provider 208b, assigning part 210 assigns the translation task to service provider 208b, which in turn transmits the WordPerfect document over the Internet via electronic mail to the human translator.

The Word Perfect document is received on a computer used by the human translator. The translator then translates the document according to his own schedule. During this time, which may last several hours or several days, provider communications part 218 of job management apparatus 204 sends provider manager 216 report_now signals which are, in turn, communicated to service provider 208b. In response to these signals, service provider 208b sends status_report signals to contact part 212 of the job manager, estimating the amount of work done and the time until completion. In some embodiments, service provider 208b also sends provider manager 214 status_report signals.

Eventually, service provider 208b sends a task_complete signal to contact part 212 and returns the document in French. When assigning part 210 subsequently receives a request_work signal from a third service provider, the French Word Perfect document is submitted electronically to the third service provider for printing and delivery.

In a third example, the input file includes an image document which has been electronically scanned into machine-readable form. The user sends the document via facsimile transmission to FAX server 102b. The transmission includes a cover page for the document containing information describing what services are required to process the document. This may include, for instance, an image resolution to which the document should be converted. Also, in this example, several e-mail addresses for intended recipients of the converted document are contained on the cover page.

The input file is captured by client communications part 112. The instructions on the cover page are decoded and stored as a batch job in job database 114. The program automatically associated with the job references the service which provides conversion planning. The image document is stored in repository 116.

At some later time, retrieving part 118 retrieves the file from the repository, and extracting part 120 in response to the program extracts the entire job as a task The assigning part in response to receiving a request_work signal from a service provider which provides conversion planning submits the job to the service provider.

The conversion planner breaks the job into two tasks which include converting the image file to a different resolution, and e-mailing the converted image file to the intended recipients. The conversion planner then references the provider matrix to determine an efficient way to perform each task. After referencing the provider matrix the conversion planner creates a program which includes each step and all the dependency information for each step and submits the batch job and the program associated with the job to the job management apparatus.

The job management apparatus receives the job and treats it as if it were an original job and program sent by a client and performs the job as described above. The steps are queued in the queue 122 based on the program and the different tasks are sent to the service provider that sends a request_work signal indicating that it is capable of performing the task. At least one service provider performs each of these services, and the tasks are executed using the methods described above. The converted image document may be attached to an e-mail message using methods known to those skilled in the art.

Another example of a batch job which may be executed according to embodiments of the present invention includes the tasks of filtering an image file, changing the format of the image file, compressing the image file, attaching the compressed image to an e-mail, then sending the e-mail to a number of recipients.

In all of the examples above, processing of the batch job appears to be fully automated to the user. Thus, the user does not need to concern himself with the management and execution of the particular services required to achieve the results he desires. But in actuality, a number of services are often being performed. Batch job execution systems constructed according to an embodiment of the present invention manage the performance of an arbitrary variety of such services with a variety of implementations.

The foregoing description of embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined only by the following claims and their equivalents.

What is claimed is:

1. A method for preparing a job for execution by a batch job execution system, comprising the steps of:
receiving a job from an external source, wherein the job includes at least one task;
selecting a program, subsequent to receiving the job, which includes a first part and a second part, which may be used in executing the job;
preparing a batch job by associating the selected program with the job; and,
transmitting the batch job toward the batch job execution system.

2. The method of claim 1, wherein the first part of the program comprises:
at least one step, wherein the step identifies a service which is offered by the batch job execution system which can be used in executing at least a portion of one of the tasks of the batch job; and,
scheduling information, which organizes the order in which the steps may be performed by the batch job execution system and whether the steps may be performed independent of one another or in parallel with one another.

3. The method of claim 1, wherein the second part of the program is for executing at least a portion of one of the tasks of the batch job; and, is further capable of generating additional steps to be executed by the batch job execution system in order to complete the task being executed.

4. The method of claim 1, wherein the program is selected from a plurality of programs stored in a library, wherein the programs are capable of being executed by the batch job execution system.

5. The method of claim 1, further comprising the step of, receiving a signal from the external source designating the program to be selected.

6. The method of claim 1, further comprising the steps of:
receiving a first signal from the external source, which identifies the input type of information included in the job;
receiving a second signal from the external source, which identifies the desired output type of information to be obtained when the job has been executed; and,
wherein the step of selecting a program is in response to receiving the first and second signal.

7. The method of claim 1, further comprising the steps of:
determining the input type information included in the received job;
receiving a signal from the external source, which identifies the desired output to be obtained when the job has been executed; and,
wherein the step of selecting a program is in response to the steps of determining and receiving.

8. A method for preparing a batch job for execution by a batch job execution system, comprising the steps of:
receiving a batch job comprising at least one task, by a first part of the batch job execution system, wherein the batch job may be executed using a plurality of service providers;
determining for the tasks of the batch job a service type, offered by a service provider of the batch job execution system, which may be used for performing the task;
creating a step for each task, wherein the steps comprise a first reference to the determined service type needed to perform the task, and a second reference to the task;
determining an efficient way to organize the created steps for execution by the batch job execution system;
preparing a program which comprises the created steps, and the organization of steps for execution by the batch job execution system; and,
transmitting the batch job and the prepared program toward a second part of the batch job execution system.

9. The method of claim 8, wherein the step of determining a service type further comprises the step of, referencing a provider matrix, wherein the provider matrix comprises:
a list of services which are capable of being performed by the batch job execution system; and,
a list of service providers which are capable of performing the services.

10. The method of claim 8, wherein the program is for, executing at least a portion of one of the tasks of the batch job; and, is further capable of generating additional steps to be executed by the batch job execution system in order to complete the task being executed.

11. A method for preparing and executing a task of a batch job by a batch job execution system, comprising the steps of:
receiving the task of the batch job which is to be executed by a service provider;
making a call to start a session with a remote platform, in response to receiving the task;
making a call to put, subsequent to making a call to start a session, which transfers at least a portion of the information in the task to be executed to the remote platform;
making a call to convert, subsequent to making a call to put, which instructs the remote platform to perform a function on the information transferred to the remote platform;
making a call to get, subsequent to making a call to convert which retrieves the converted information from the remote platform;
repeating each step of making a call to put, convert and get until the task is completed; and,
making a call to end the session with the remote platform.

12. The method of claim 11, wherein the step of making a call to start a session further comprises creating a unique address which identifies the session; and the step of making a call to end the session terminates the unique address.

13. The method of claim 11, wherein the remote platform is operating on a Windows based machine; and the service provider is operating on a UNIX based machine.

14. A method for preparing and executing a task of a batch job by a batch job execution system, comprising the steps of:
receiving the task to be executed from a first portion of the batch job execution system by a second portion of the batch job execution system;
creating a plurality of steps, in response to receiving the task, which must be executed by a plurality of other service providers in order to complete the task;
transmitting the plurality of steps to be completed toward the first portion of the batch job execution system for execution;
receiving a plurality of results from the first portion of the batch job execution system once the plurality of steps have been executed; and,
preparing an output comprising the plurality of results.

15. The method of claim 14, wherein the first portion of the batch job execution system is a job management apparatus.

16. The method of claim 14, wherein the second portion of the batch job execution system is a service provider.

17. An apparatus for preparing a job for execution by a batch job execution system, comprising:
a client, which is capable of receiving a job from an external source, wherein the job includes at least one task, wherein the client is for:
electing a program which comprises a first part and a second part, wherein the program may be used in executing the job;
reparing a batch job by associating the selected program with the job; and,
ransmitting the batch job toward the batch job execution system.

18. The apparatus of claim 17, wherein the first part of the program comprises:
at least one step, wherein the steps identify a service which is offered by the batch job execution system which may be used in executing at least a portion of one of the tasks of the batch job; and,
scheduling information, which organizes the order in which steps may be performed by the batch job execution system and whether the steps may be performed independent of one another or in parallel with one another.

19. The apparatus of claim 17, wherein the second part of the program is for:
executing at least a portion of one of the tasks of the batch job; and, is further capable of generating additional steps to be executed by the batch job execution system in order to complete the task being executed.

20. The apparatus of claim 17, wherein the program is selected from a plurality of programs stored in a library, which are capable of being executed by the batch job execution system.

21. The apparatus of claim 17, wherein the client is further for, receiving a signal from the external source designating the program to be selected.

22. The apparatus of claim 17, wherein the client is further for:
receiving a first signal from the external source which identifies the input type of information included in the job;
receiving a second signal from the external source which identifies the desired output type of information to be obtained when the job has been executed; and,
selecting a program based on the first and second signal, which includes information necessary for executing the job.

23. The apparatus of claim 17, wherein the client is further for:
determining the input type information included in the received job;
receiving a signal from the external source which identifies the desired output to be obtained when the job has been executed; and,
selecting a program based on input type and the desired output, which includes information necessary for executing the job.

24. An apparatus for preparing a batch job for execution by a batch job execution system, comprising:
a service provider, for:
receiving a batch job comprising at least one task, wherein the batch job may be executed using a plurality of service providers:
determining for the tasks of the batch job a service type, offered by a service provider of the batch job execution system, which may be used for performing the task;
creating a step for the tasks, wherein the step comprises a references to the determined service type needed to perform the task, and a reference to the task;
determining an efficient way to organize the created steps for execution by the batch job execution system;
preparing a program which comprises the created steps; and the organization of the steps for execution by the batch job execution system; and,
transmitting the batch job and the prepared program toward a job management apparatus.

25. The apparatus of claim 24, wherein the service provider references a matrix, wherein the matrix comprises:
a list of services which are capable of being performed by the batch job execution system; and,
a list of service providers which are capable of performing the services.

26. The apparatus of claim 24, wherein the program is for executing at least a portion of one of the tasks of the batch job, and is further capable of generating additional steps to be executed by the batch job execution system in order to complete the task being executed.

27. An apparatus for preparing and executing a task of a batch job by a batch job execution system, comprising:
a service provider, which is capable of receiving the task of the batch job which is to be executed wherein the service provider is for:
making a call to start a session with a remote platform, in response to receiving the task;
making a call to put, subsequent to making a call to start a session, which transfers at least a portion of the information in the task to be executed to the remote platform;
making a call to convert, subsequent to making a call to put, which instructs the remote platform to perform a function on the information transferred to the remote platform;
making a call to get, subsequent to making a call to convert, which retrieves the converted information from the remote platform;
repeating each step of making a call to put, convert and get until the task is completed; and,
making a call to end the session with the remote platform.

28. The apparatus of claim 27, wherein the remote platform is operating on a Windows based machine; and the service provider is operating on a UNIX based machine.

29. An apparatus for preparing and executing a task of a batch job by a batch job execution system, comprising:
a service provider, which is capable of receiving the task to be executed from a job management apparatus, wherein the service provider is for:
creating a plurality of steps which may be executed by a plurality of other service providers in order to complete the task;
transmitting the plurality of steps to be completed toward the job management apparatus for execution;
receiving a plurality of results from the job management apparatus once the plurality of steps have been executed; and,
preparing an output comprising the plurality of results.

30. An article of manufacture including an information storage medium wherein is stored information comprising:
a client software component for:
receiving a job from an external source, wherein the job may be executed using a plurality of service provider software components;
selecting a program software component which references at least one of the plurality of service provider software components;
preparing a batch job software component by associating the selected program software component with the job; and,
transmitting the batch job software component toward a job management apparatus software component.

31. An article of manufacture including an information storage medium wherein is stored information comprising:
a service provider software component, which offers a service of conversion planning, wherein the service provider software component is for:
receiving a batch job software component;
separating the batch job software component into a plurality of tasks, wherein the tasks may be performed by a service provider software component of a batch job execution system;
determining for the tasks a service type, offered by one of the service provider software components, which may be used for performing the task;
creating a step for each task, wherein the steps comprise a references to the service type needed to perform the task and a reference to the task;
determining an efficient way to organize steps for execution by the batch job execution system;
preparing a program software component, which comprises the steps and information designating the organization of the steps for execution by the batch job execution system; and,
transmitting the batch job software component and the program software component toward a job management apparatus.

32. The article of manufacture of claim 40, wherein the service provider software component, which offers the service of conversion planning, references a provider matrix software component which comprises:
a list of services which are capable of being performed by the batch job execution system; and,
a list of service provider software components which are capable of performing the services.

33. The article of manufacture of claim 40, wherein the program software component is for, executing at least a portion of one of the tasks of the batch job software component; and, is further capable of generating additional steps to be executed by the batch job execution system in order to complete the task being executed.
